(19) United States
(12) Patent Application Publication
(10) Pub. No.: US 2010/0155495 A1
(43) Pub. Date: Jun. 24, 2010

(54) HEATING DEVICE USING AN EXHAUSTED ENGINE HEAT

(76) Inventor: Hyun-Sang Park, Busan (KR)

Correspondence Address: HYUN JONG PARK;Park & Associates IP Law LLC, 265 Bic Drive, Suite 106, Milford, CT, 06461, US

(21) Appl. No.: 12/293,768

(22) PCT Filed: Feb. 1, 2007
(86) PCT No.: PCT/KR07/00538

§ 371 Date: Sep. 19, 2008

(30) Foreign Application Priority Data
Mar. 20, 2006 (KR) 10-2006-0025464

(51) Int. Cl. B60H 1/18

(52) U.S. Cl. 237/12.3 R

(57) ABSTRACT

Disclosed herein is a heating device using waste engine heat. When an engine is stopped for a driver to rest in a vehicle or leave the vehicle for a meal, a manipulation switch in the vehicle is turned on to forcibly circulate coolant heated by engine heat, thus heating the interior of the vehicle. The device includes a main body which generates rotating force by current supplied from a vehicle battery, when an engine is stopped. A receiving part is received in the main body, and prevents coolant from flowing into the main body. A rotor is inserted into the receiving part, receives the coolant, and is rotated depending on a varying polarity, thus discharging the coolant. A lid introduces the coolant from the engine through one side, supplies the coolant to the rotor, and discharges the coolant to a heater coupled to the other side.

### TECHNICAL FIELD

The present invention relates, in general, to a device for heating the interior of a vehicle and, more particularly, to a heating device using waste engine heat, including a main body which is controlled so that an electric current is supplied from a battery of a vehicle for a predetermined period, when an engine is stopped, and generates rotating force when the electric current is connected to the main body, a receiving part which is received in the main body and prevents coolant from flowing into the main body, a rotor which is inserted into the receiving part, receives the coolant, and is rotated depending on a varying polarity when the electric current is connected to the main body, thus discharging the coolant, and a lid which introduces the coolant from the engine through one side of the lid, supplies the coolant to the rotor, and discharges the coolant, which has rotating force while passing through the rotor, to a heater coupled to the other side of the lid.

### BACKGROUND ART

Generally, vehicles are provided with heating devices so as to keep the interiors of the vehicles warm. The heating devices may use heat generated from an engine, or use a heat source other than the engine. According to the heat source, the heating devices are classified into a hot-water-type heating device using coolant of an engine, and a combustion-type heating device which does not use the exhaust heat of an engine but uses an independent burner.

The hot-water-type heating device is widely used in a water-cooled-engine vehicle, and is the most widely used heating device. This circulates the coolant of the engine to absorb waste heat of the engine. That is, the heated coolant flows to a heater, and air blows through the heater by a blower, so that hot air is blown from the heater.

In other words, some of the coolant which is heated by the engine heat is fed into the heater, and air circulates around the heater. Thereby, the air is heated and is supplied to the interior of the vehicle using the blower, so that the interior of the vehicle is heated.

However, the conventional hot-water-type heating device for vehicles is operated when the engine is being operated. When the engine is stopped, the heating device also stops operating. Thus, even when a driver leaves a vehicle for a while to have a meal after driving or stops the vehicle during driving on an expressway so as to rest in the vehicle, the engine must not be stopped so as to keep the interior of the vehicle warm.

Since the engine continues operating, it is difficult for a driver to comfortably leave the vehicle, and the driver cannot efficiently utilize time. Further, the continuous operation of the engine causes the waste of fuel, generates much exhaust fumes due to incomplete combustion during idle operation, and causes the damage to a gasket of the engine and the early wearing of the engine. Further, noise caused by the operation of the engine hinders the driver from resting in the vehicle.

A large vehicle in particular, such as a large truck or a trailer, suffers heavier damage from the continuous operation of the engine. Further, such a large vehicle must wait for a long time in a working area or a cargo handling area and must run for a long time, so that a driver frequently rests in the vehicle. At this time, in order to keep the interior of the vehicle warm, the vehicle is idly operated or an additional heating device is used in the vehicle. The heating device excessively increases the consumption of a vehicle's battery power, so that the battery may be undesirably discharged and thus may make it difficult to start the vehicle.

Korean U.M. Registration No. 0265114, which was filed by the applicant of this invention, discloses a heating device, which has a control valve on a coolant line, thus keeping the interior of a vehicle warm even after an engine has been stopped. However, the conventional heating device has a problem in that the control valve is installed in an engine room and is operated through a manual manipulation, so that the engine room must be opened whenever the control valve is operated, thus inconveniencing a driver. The conventional heating device has another problem in that the supply amount of coolant is insufficient to heat the interior of the vehicle. Further, if the heating device is installed in the engine room, an additional pipe must be installed, so that the construction is complex, and the installation and maintenance are difficult.

### DISCLOSURE OF INVENTION

### Technical Problem

Accordingly, the present invention has been made keeping in mind the above problems occurring in the prior art, and an object of the present invention is to provide a heating device using waste engine heat, which is constructed so that a coolant line coupling an engine with a heater is cut at a predetermined position thereof and the heating device is connected to the cut portion of the coolant line, without the necessity of installing an additional line for supplying coolant, when the heating device according to this invention is installed in an engine room, thus allowing a sufficient amount of coolant required to heat the interior of a vehicle to be supplied to the heating device, affording convenient maintenance, and promoting efficiency.

Another object of the present invention is to provide a heating device using waste engine heat, which includes a control unit having a temperature check part, a voltage check part, and an operation time check part so as to check a battery voltage, a temperature, and an operation time, thus preventing the discharge of the battery due to the excessive use of the battery, and efficiently controlling the temperature in a vehicle.

A further object of the present invention is to provide a heating device using waste engine heat, in which a projection is provided in a lid to increase the hydraulic energy of coolant, prior to discharging the coolant, and the inner radius of the lid is changed along a predetermined direction, thus promoting efficiency.

Yet another object of the present invention is to provide a heating device using waste engine heat, in which a water inlet part into which coolant fed from an engine flows is vertically and horizontally spaced apart from a water outlet part for discharging the coolant to a heater, by predetermined intervals, thus allowing the heating device to be easily installed in an engine room, and promoting efficiency.

A still further object of the present invention is to provide a heating device using waste engine heat, which is constructed so that coolant circulates not when an engine is operated but when the engine is stopped, thus saving fuel.

### Technical Solution

In order to accomplish the objects, the present invention provides embodiments of a heating device having the following construction.

According to a first embodiment of the invention, the present invention provides a heating device using waste engine heat, including a main body generating rotating force by an electric current which is supplied from a battery of a vehicle to the main body for a predetermined period, when an engine is stopped; a receiving part received in the main body, and preventing coolant from flowing into the main body; a rotor inserted into the receiving part, and receiving the coolant, the rotor rotated depending on a varying polarity, thus discharging the coolant from the rotor; and a lid introducing the coolant from the engine through a first side of the lid, supplying the coolant to the rotor, and discharging the coolant, which has swirling force while passing through the rotor, to a heater coupled to a second side of the lid.

According to a second embodiment of the invention, in the heating device of the first embodiment, the main body includes a driving part for driving the rotor and a control unit for controlling the driving part, the receiving part includes a body which is coupled to the main body and receives the rotor therein, the rotor includes a rotor body which is operated in conjunction with the driving part to be rotated, and a water outlet part for discharging the coolant from the rotor, and the lid includes a water inlet part for introducing the coolant from the engine, a coolant storage part for temporarily storing the coolant fed through the water inlet part, and a water outlet part for discharging the coolant from the coolant storage part to the heater.

According to a third embodiment of the invention, in the heating device of the second embodiment, the control unit includes a voltage check part for periodically checking an operating voltage of the vehicle battery, an operation time check part for checking an operation time of the heating device, a temperature check part for checking a temperature of the coolant, and a control part for wholly controlling the heating device, based on data transmitted from the voltage check part, the operation time check part, and the temperature check part.

According to a fourth embodiment of the invention, in the heating device of the third embodiment, the body of the receiving part includes a support shaft that allows the rotor body to be rotated without deviating from a center, and the rotor includes a second insert hole that is fitted over the support shaft.

According to a fifth embodiment of the invention, in the heating device of the second embodiment, the coolant storage part further includes at a predetermined position therein a projection, and a radius of the coolant storage part is increased in a circumferential direction from the projection, so that moment is increased when the coolant rotates by rotation of the rotor, and thereby the coolant is discharged from the coolant storage part while having increased hydraulic energy.

According to a sixth embodiment of the invention, in the heating device of the second embodiment, the lid includes a guide protrusion for easily supplying the coolant to the rotor, and the rotor further includes a water inlet passage having a water inlet protrusion which corresponds to the guide protrusion so as to easily introduce the coolant into the rotor.

According to a seventh embodiment of the invention, in the heating device of the fourth embodiment, the lid further includes a coupling protrusion having a coupling hole which is coupled to the support shaft protruding from the second insert hole.

According to an eighth embodiment of the invention, in the heating device of the second embodiment, the water inlet part extends upwards from the lid, and then is bent at a predetermined curvature in a direction opposite that of the water outlet part in such a way as to extend laterally.

According to a ninth embodiment of the invention, in the heating device of the second embodiment, the receiving part further includes a flange, having a protruding surface inserted into the main body, a first coupling surface supported on an upper surface of the main body, a second coupling surface supporting the lid, a third coupling surface coupled to the lid, and primarily sealing a gap between the receiving part and the lid so as to prevent the coolant from leaking out, and a packing groove into which a packing member is inserted, thus secondarily sealing the gap between the receiving part and the lid.

According to a tenth embodiment of the invention, in the heating device of the ninth embodiment, the lid further includes a lid flange, having a coupling surface coupled to the second coupling surface, a sealing groove into which the third coupling surface is inserted, a sealing surface sealing the packing groove, and a temporary storage groove for temporarily storing the coolant which leaks through the sealing surface.

According to an eleventh embodiment of the invention, in the heating device of the tenth embodiment, the lid flange includes on an outer circumference thereof a plurality of third locking parts each having a through hole, the flange of the receiving part includes on an outer circumference thereof a plurality of second locking parts each having a through hole, and the main body includes on an outer circumference thereof a plurality of first locking parts each having an internal threaded through hole, the locking parts being integrally coupled to each other using a fastening means.

### Advantageous Effects

The present invention solves the problems of the prior art, using the above-mentioned construction, and has the following effects.

The present invention provides a heating device using waste engine heat, which is constructed so that a coolant line coupling an engine with a heater is cut at a predetermined position thereof and the heating device is connected to the cut portion of the coolant line, without the necessity of installing an additional line for supplying coolant, when the heating device according to this invention is installed in an engine room, thus allowing a sufficient amount of coolant required to heat the interior of a vehicle to be supplied to the heating device, affording convenient maintenance, and promoting efficiency.

The present invention provides a heating device using waste engine heat, which includes a control unit having a temperature check part, a voltage check part, and an operation time check part so as to check a battery voltage, a temperature, and an operation time, thus preventing the discharge of the battery due to the excessive use of the battery, and efficiently controlling the temperature in a vehicle.

The present invention provides a heating device using waste engine heat, in which the inner radius of a coolant storage part is increased continuously or discontinuously in a circumferential direction from a projection, so that the moment of coolant discharged from a rotor is increased when the rotor rotates, and the hydraulic energy of the coolant discharged through a water outlet part is increased, thus promoting efficiency.

The present invention provides a heating device using waste engine heat, in which a water inlet part into which coolant fed from an engine flows is vertically and horizontally spaced apart from a water outlet part for discharging the coolant to a heater, by predetermined intervals, thus allowing the heating device to be easily installed in an engine room, and promoting efficiency.

The present invention provides a heating device using waste engine heat, which is constructed so that coolant circulates not when an engine is operated but when the engine is stopped, thus saving fuel.

The present invention provides a heating device using waste engine heat, in which a rotor having polarity opposite to that of a driving part of a main body is pulled downwards strongly by magnetic force, thus preventing internal components from wearing out due to the rotation of the rotor, therefore allowing the heating device to be used for a lengthy period of time.

The present invention provides a heating device using waste engine heat, which can seal a gap between parts, inserts a packing member into the gap to more efficiently seal the gap, and has a groove for temporarily storing coolant when some of the coolant leaks out, thus efficiently preventing the leakage of the coolant.

### BRIEF DESCRIPTION OF THE DRAWINGS

FIG. 1 is a perspective view showing a heating device using waste engine heat, according to the preferred embodiment of the present invention;

FIG. 2 is a perspective view of the heating device, according to the preferred embodiment of the present invention;

FIG. 3 is an exploded perspective view of the heating device, according to the preferred embodiment of the present invention;

FIG. 4 is a plan view of a main body, according to the preferred embodiment of the present invention;

FIG. 5 is a block diagram showing the construction of a control unit, according to the preferred embodiment of the present invention;

FIG. 6 is a perspective view of a receiving part, according to the preferred embodiment of the present invention;

FIG. 7 is a vertical sectional view of the receiving part, according to the preferred embodiment of the present invention;

FIG. 8 is a perspective view of a rotor, according to the preferred embodiment of the present invention;

FIG. 9 is a top perspective view of a lid, according to the preferred embodiment of the present invention;

FIG. 10 is a bottom perspective view of the lid, according to the preferred embodiment of the present invention;

FIG. 11 is a bottom plan view of the lid, according to the preferred embodiment of the present invention; and

FIG. 12 is a schematic view showing the use of the heating device using waste engine heat, according to the present invention.

### DESCRIPTION OF REFERENCE CHARACTERS OF IMPORTANT PARTS

1: main body 2: receiving part 3: rotor 4: lid

5: heating device using waste engine heat

11: driving part 12: receiving part insert cavity

13: control unit 14: power line 15: 1st locking parts

21: body of receiving part 22: flange

31: rotor body 32: water outlet part of rotor 33: water inlet passage

41: lid flange 42: 1st step 43: 2nd step 44: water inlet part 45: water outlet part

100: vehicle 101: engine 102: radiator 103: water pump 104: thermostat 105: heater

121: coils 122: curved plates 131: voltage check part 132: operation time check part 133: temperature check part 134: control part 151: holes

211: rotor insert cavity 212: support shaft protrusion 213: support shaft 221: protruding surface 222: 1st coupling surface 223: 2nd coupling surface 224: 3rd coupling surface 225: packing groove 226: 2nd locking parts

311: 1st insert hole 312: 2nd insert hole 321: water outlet holes 331: water inlet protrusion 332: discharge holes

411: coupling surface 412: sealing surface 413: sealing groove 414: temporary storage grooves 415: 3rd locking parts 421: coolant storage part 422: water outlet hole 431: guide protrusion 432: coupling protrusion 433: coupling hole 441: water inlet hole 4211: projection

R1, R2, R3, R4, R5, R6, R7, R8: radius

### MODE FOR THE INVENTION

Hereinafter, the preferred embodiment of the present invention will be described in detail with reference to the accompanying drawings.

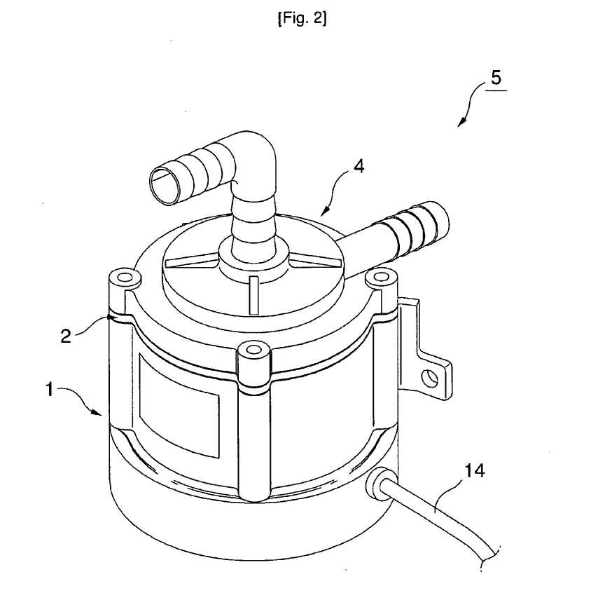

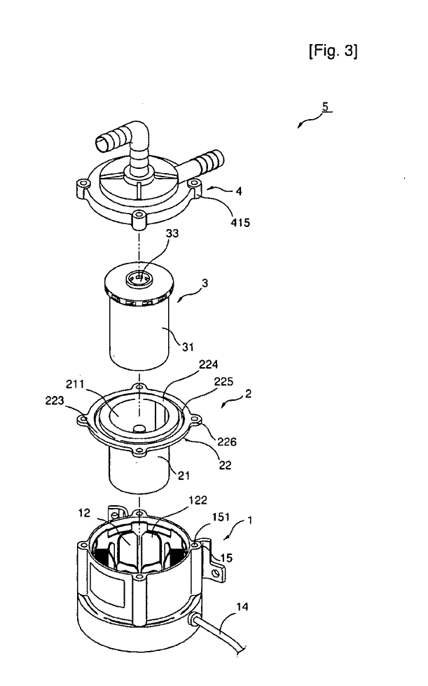

FIG. 2 is a perspective view of a heating device, according to the preferred embodiment of the present invention, and FIG. 3 is an exploded perspective view of the heating device, according to the preferred embodiment of the present invention.

Referring to FIGS. 2 and 3, the heating device 5 using waste engine heat includes a main body 1, a receiving part 2, a rotor 3, and a lid 4.

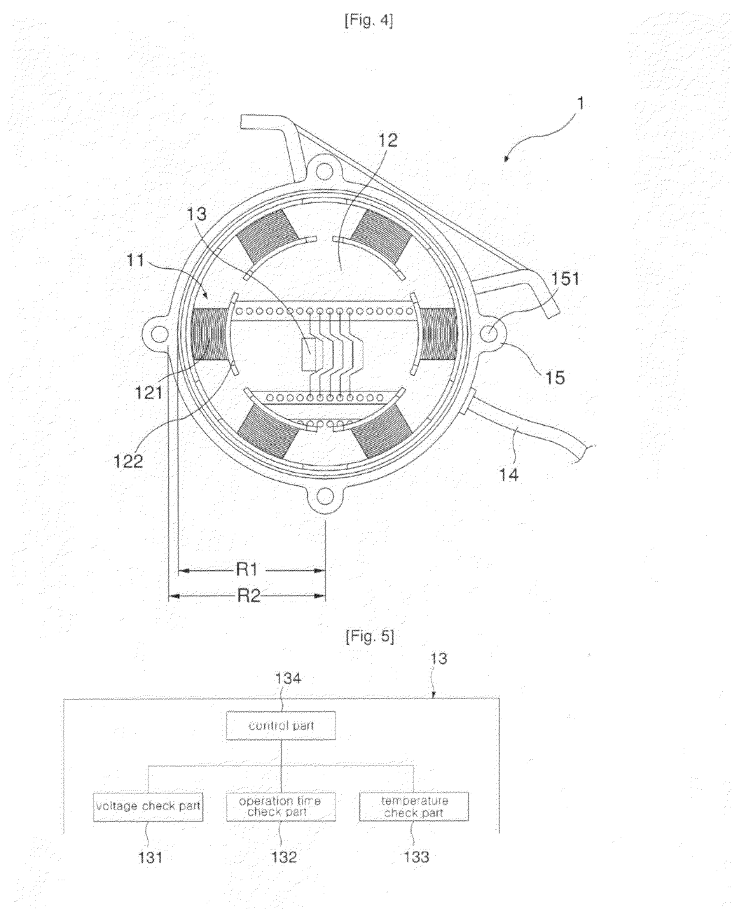

FIG. 4 is a plan view of the main body, according to the preferred embodiment of the present invention.

Referring to FIGS. 3 and 4, the main body 1 is open at one side thereof and is closed at the other side thereof. The main body has the shape of a hollow cylinder which has a predetermined radius R1 and a predetermined radius R2. The main body includes a driving part 11, a receiving part insert cavity 12, a control unit 13, a power line 14, and first locking parts 15.

The driving part 11 includes coils 121 and a plurality of curved plates 122 so that the driving part is operated in conjunction with the rotor 3, which will be described below in detail and comprises a permanent magnet, thus serving as a motor. Thus, when an electric current is supplied, through the power line 14 for supplying power, to the heating device 5 using waste engine heat, the coils 121 and the plurality of curved plates 122 of the driving part 11 serve as a stator of a general motor, thus causing the rotor 3 to be rotated. This will be described below in detail with reference to the operation of the heating device 5 using waste engine heat.

The receiving part insert cavity 12 is surrounded by the plurality of curved plates 122 of the driving part 11, thus defining a space having a predetermined diameter for accommodating the receiving part 2 therein.

FIG. 5 is a block diagram showing the construction of the control unit, according to the preferred embodiment of the present invention.

Referring to FIGS. 4 and 5, the control unit 13 is a control board which is provided in the lower portion of the main body 1, and wholly controls the heating device 5 using waste engine heat so as to prevent the discharge of a battery due to the excessive use of the battery and efficiently control the temperature in a vehicle. The control unit includes a voltage check part 131, an operation time check part 132, a temperature check part 133, and a control part 134.

The voltage check part 131 checks the voltage of the battery, when receiving an actuating signal of the heating device 5 using waste engine heat. The voltage check part 13 transmits the checked data to the control part 134. Even when the heating device 5 is being operated, the voltage check part frequently checks the voltage of the battery, and transmits the checked data to the control part 134.

The operation time check part 132 checks the operation time of the heating device 5 using waste engine heat, and transmits the checked data to the control part 134 so as to prevent the excessive consumption of the vehicle battery. Further, the heating device 5 using waste engine heat is preferably operated only for about one hour by the operation time check part 132, and the temperature of coolant is high just as the engine is stopped. In consideration of this fact, until 30 minutes have passed since the heating device 5 using waste engine heat starts to operate by turning on a heater button, the rotor 5 preferably rotates at a slow speed so as to reduce the consumption of the battery power. After 30 minutes have passed, the rotor 5 rotates at a high speed. Thereby, even if the temperature of the coolant is lowered, the rotor increases the supplied quantity of coolant. In this way, a proper indoor temperature can be maintained.

The temperature check part 133 frequently checks the temperature of the coolant, and transmits the checked data to the control part 134. It is preferable that the heating device 5 using waste engine heat not be operated when the coolant is less than 30° C.

The control part 134 is a microprocessor which serves to wholly control the heating device 5 using waste engine heat, the voltage check part 131, the operation time check part 132, and the temperature check part 133. The control part compares the voltage transmitted from the voltage check part 131 with a reference voltage, and stops the heating device when the transmitted voltage is less than a predetermined voltage. Here, the reference voltage may be set as desired, but is preferably a minimum voltage which is required to start the vehicle. If the heating device 5 using waste engine heat is operated even when the voltage of the battery is below the reference voltage, it is difficult to start the vehicle because the voltage of the battery becomes below the reference voltage. Thus, the voltage of the battery must be always checked.

As shown in FIG. 3, the power line 14 is connected to the sidewall of the lower portion of the main body 1. The power line supplies power to the heating device 5 using waste engine heat, when the control unit 13 receives the actuating signal and operates the heating device.

As shown in FIG. 4, the first locking parts 15 are a plurality of protruding parts which are provided on the outer circumference of the upper end of the main body 1 at regular intervals, and have threaded holes 151 into which bolts are longitudinally inserted and tightened. The first locking parts are integrally fastened to the receiving part 2 and the lid 4, which will be described below in detail, using fastening means, such as bolts and nuts, thus firmly locking the heating device 5 using waste engine heat.

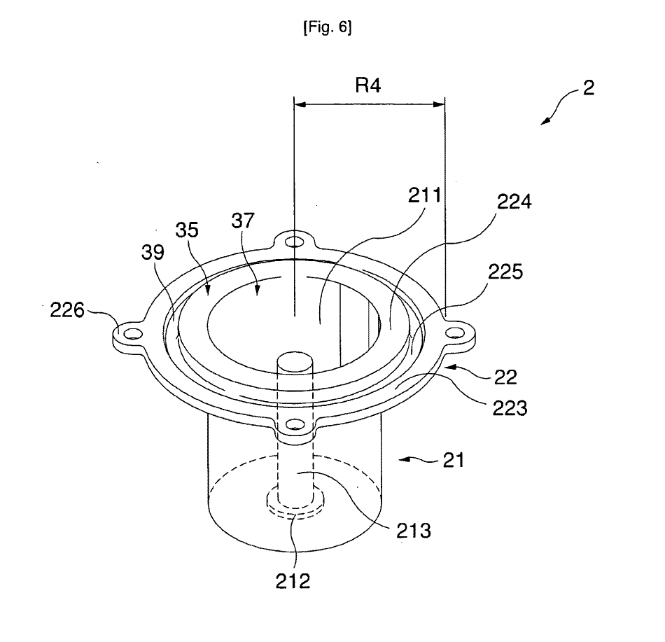

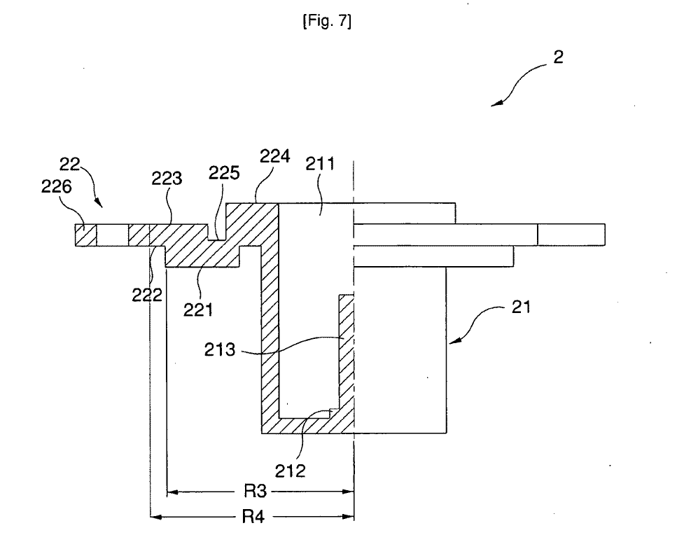

FIG. 6 is a perspective view of the receiving part, according to the preferred embodiment of the present invention, and FIG. 7 is a vertical sectional view of the receiving part, according to the preferred embodiment of the present invention.

Referring to FIGS. 3, 6, and 7, the receiving part 2 includes a body 21 and a flange 22.

The body 21 of receiving part has the shape of a hollow cylinder which is open at one side thereof and is closed at the other side thereof. The outer circumference of the body has a diameter which is almost equal to or smaller than that of the space defined by the plurality of curved plates 122, so that the body is inserted into the receiving part insert cavity 12 of the main body 1. The body of receiving part includes a rotor insert cavity 211, a support shaft protrusion 212, and a support shaft 213.

The rotor insert cavity 211 is formed in the body 21 of receiving part to define a space for accommodating the rotor 3 which will be described below in detail.

The support shaft protrusion 212 is the shape of a disc which has a smaller diameter than that of the rotor insert cavity 211 and extends upwards from the bottom of the rotor insert cavity 211 to a predetermined length. The support shaft protrusion is coupled to the lower portion of the rotor 3 so as to prevent the movement of the rotor 3 when the heating device 5 using waste engine heat is not operated.

The support shaft 213 is a cylindrical shaft which has a smaller diameter than that of the support shaft protrusion 222 and extends upwards from the upper surface of the support shaft protrusion to a predetermined length. The support shaft allows the rotor 3 to rotate without deviating from the center, when the heating device 5 using waste engine heat is operated.

The flange 22 is the shape of a hollow ring having a radius R4 which is equal to the radius R2 of the main body 1. The flange is connected at the inner circumference thereof to the body 21 of receiving part, and includes a protruding surface 221, a first coupling surface 222, a second coupling surface 223, a third coupling surface 224, a packing groove 225, and second locking parts 226.

The protruding surface 221, which has a smaller diameter than that of the flange 22, extends downwards from the lower surface of the flange to a predetermined length, thus forming a step. The radius R3 of the outer circumference of the protruding surface is formed to be equal to the radius R1 of the main body 1. Thereby, when the receiving part 2 is held in the main body 1, the sidewall of the protruding surface 221 contacts the inner circumference of the main body 1.

The first coupling surface 222 is the lower surface of the flange 22, which is formed outside the protruding surface 221. The radius R4 of the outer circumference of the first coupling surface and the radius R3 of the inner circumference of the first coupling surface are equal to the radius R2 and the radius R1 of the main body 1, respectively. Thus, when the receiving part is coupled to the main body 1, the first coupling surface supports the receiving part 2.

The second coupling surface 223 is the upper surface of the flange 21, which supports and is coupled to the lid 4 that will be described below in detail.

The third coupling surface 224, which has a smaller diameter than that of the second coupling surface 223, is formed inside the second coupling surface, and extends upwards to a predetermined length, thus forming a step. The inner circumference of the third coupling surface is connected to the rotor insert cavity 211 of the body 21. When the assembly of the heating device 5 using waste engine heat, which will be described below, is performed, the third coupling surface is inserted into the lid 4, thus primarily sealing a gap between the lid 4 and the receiving part 2, therefore preventing the coolant from leaking out.

The packing groove 225 is the groove which is formed between the second coupling surface 223 and the third coupling surface 224. When the assembly of the heating device 5 using waste engine heat, which will be described below, is performed, a packing member, such as an O-ring, is inserted into the packing groove 225, thus secondarily sealing the gap between the receiving part 2 and the lid 4, therefore preventing the coolant from leaking out.

The second locking parts 226 are a plurality of locking parts which are provided on the outer circumference of the flange 22 at regular intervals and have through holes each having a diameter which corresponds to a diameter of each of the holes 151 of the first locking parts 15 that have been described above.

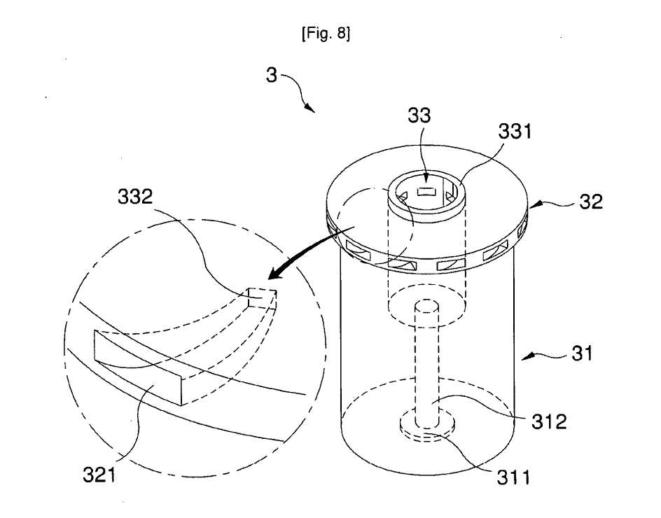

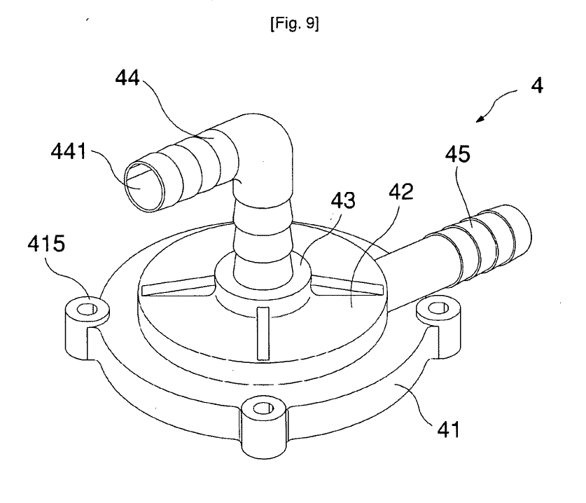

FIG. 8 is a perspective view of the rotor, according to the preferred embodiment of the present invention.

Referring to FIGS. 3 and 8, the rotor 3 includes a rotor body 31, a water outlet part 32, and a water inlet passage 33.

The rotor body 31 has the shape of a hollow cylinder which has the water inlet passage 33, that will be described below in detail, on the upper portion in the cylinder, and is made of a permanent magnet. The rotor body is operated in conjunction with the driving part 11 of the main body 1, thus rotating the rotor 3. A first insert hole 311 and a second insert hole 312 are formed in the lower portion of the rotor body.

The first insert hole 311 is the hole which has a smaller diameter than that of the bottom of the rotor 3 and extends upwards from the bottom of the rotor 3 to a predetermined length. When the assembly of the heating device 5 using waste engine heat, which will be described below, is performed, the support shaft protrusion 212 of the body 21 of receiving part is inserted into the first insert hole.

The second insert hole 312 is the through hole which extends upwards from the first insert hole 311 to a predetermined length, and has a smaller diameter than that of the first insert hole, thus forming a step, and communicates with the water inlet passage 33 that will be described below in detail. When the assembly of the heating device 5 using waste engine heat, which will be described below, is performed, the support shaft 213 of the body 21 is inserted into the second insert hole.

The water outlet part 32 is the shape of a hollow ring which is provided on the upper portion of the rotor body 31 to have a larger diameter than that of the rotor body, and extends upwards from the rotor body to a predetermined length. The water outlet part includes water outlet holes 321.

As shown in the partially enlarged view of FIG. 8, each water outlet hole 321 is formed to pass from the outer circumference of the water outlet part 32 to the inner circumference thereof and to have the shape of an arc having a predetermined curvature. The plurality of water outlet holes is formed along the outer circumference of the water outlet part 32 to be spaced apart from each other by a predetermined interval. When the operation of the heating device 5 using waste engine heat, which will be described below, is performed, the water outlet holes define a coolant discharge path so that the coolant is discharged to the lid 4 as the rotor 3 rotates.

The water inlet passage 33 is the through hole which extends downwards from the upper surface the water outlet part 32 to a predetermined length in such a way as to have a smaller diameter than that of the upper surface of the water outlet part, and is formed in the rotor body 31 to communicate with the second insert hole 312. The water inlet passage 33 includes a water inlet protrusion 331 and discharge holes 332.

The water inlet protrusion 331 has the shape of a hollow cylinder which extends upwards from the upper surface of the water inlet passage 33 to a predetermined length and protrudes upwards from the water outlet part 32. In the operation of the heating device 5 using waste engine heat, which will be described below, the water inlet protrusion guides the coolant, fed through the lid 4, into the water inlet passage 33. The rotor body 31 having a polarity opposite to that of the driving part 11 of the main body 1 is pulled strongly by a magnetic force, so that the rotor body comes into close contact with the bottom of the rotor insert cavity 211 of the receiving part 2, thus allowing the coolant to be easily supplied to the water inlet passage 33. However, in order to prevent abrasion due to the contact of the lid 4 with the rotor 3 as the rotor 3 rotates, the water inlet protrusion 331 is preferably formed such that it does not contact the bottom of the lid 4.

Each discharge hole 332 is the through hole which is formed in the inner circumference of the water inlet passage 33 and is coupled to the corresponding water outlet hole 321. The discharge hole transmits the coolant, fed through the water inlet passage 33, to the water outlet part 32.

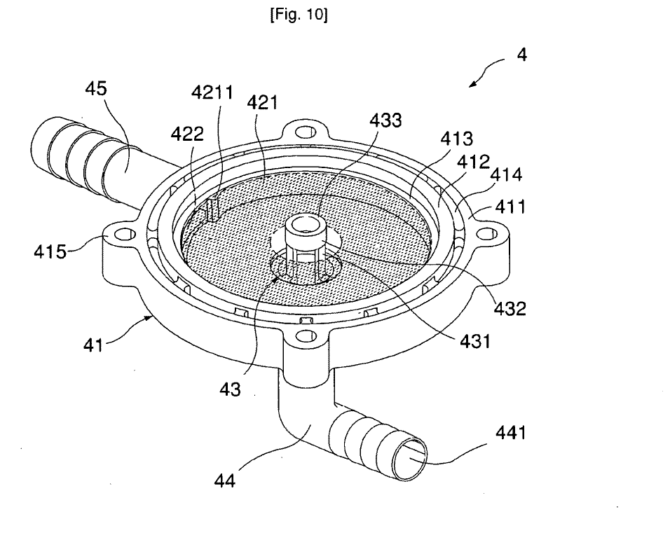

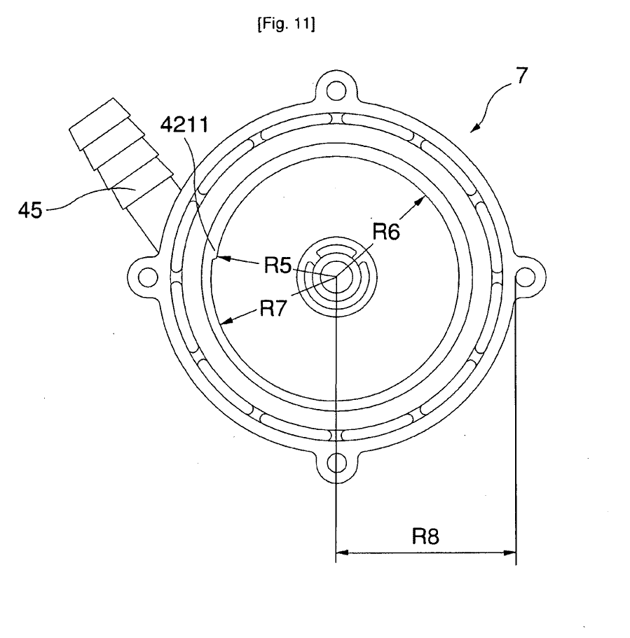

FIG. 9 is a top perspective view of the lid, according to the preferred embodiment of the present invention, FIG. 10 is a bottom perspective view of the lid, according to the preferred embodiment of the present invention, and FIG. 11 is a bottom plan view of the lid, according to the preferred embodiment of the present invention.

The lid 4 will be described with reference to FIGS. 9 to 11. The lid 4 is open at one side thereof, while being closed at the other side thereof. The lid includes a flange 41, a first step 42, a second step 43, a water inlet part 44, and a water outlet part 45.

Referring to FIG. 10, the lid flange 41 has the shape of a hollow ring which extends upwards from the open side of the lid 4 to a predetermined length, and includes a coupling surface 411, a sealing surface 412, a sealing groove 413, temporary storage grooves 414, and third locking parts 415.

Referring to FIG. 11, the coupling surface 411 is the lower surface of the flange 41, which has a radius R8 that is equal to the radius R2 of the main body 1. When the assembly of the heating device 5 using waste engine heat, which will be described below, is performed, the coupling surface is coupled to the second coupling surface 223 of the receiving part 2.

Hereinafter, the present invention will be described with reference to the direction of FIG. 10. That is, the upper portion of FIG. 10 is specified as the upper portion of the lid, and the lower portion of FIG. 10 is specified as the lower portion of the lid. Referring to FIGS. 3 and 10, the sealing surface 412 has a smaller diameter than that of the coupling surface 411, and extends upwards to a predetermined length in such a way as to protrude from the lower surface of the flange 41. When the assembly of the heating device 5 using waste engine heat, which will be described below, is performed, the sealing surface is fitted into the packing groove 225 of the receiving part 2, thus sealing the heating device 5 using waste engine heat.

The sealing groove 413 extends downwards from the inner circumference of the sealing surface 412 to a predetermined length, and then extends inwards to a predetermined length, thus forming a step. When the assembly of the heating device 5 using waste engine heat, which will be described below, is performed, the third coupling surface 224 of the receiving part 2 is inserted into the sealing groove, thus temporarily securing the lid 4 to the receiving part 2. The step formed by the sealing groove 413 contacts the third coupling surface 224, thus sealing a gap between the lid 4 and the receiving part 2.

The temporary storage grooves 414 are a plurality of grooves which are provided between the inner circumference of the coupling surface 411 and the outer circumference of the sealing surface 412 in such a way as to be spaced apart from each other by a predetermined interval. The temporary storage grooves are the space for temporarily storing the coolant when a small amount of coolant leaks from the sealing surface 412. Thus, the temporary storage grooves are a safety backup device for secondarily preventing the leakage of the coolant.

The third locking parts 415 are a plurality of locking parts which are provided on the outer circumference of the flange 41 at regular intervals and have through holes each having a diameter that is equal to that of the hole 151 of each first locking part 15. When the assembly of the heating device 5 using waste engine heat, which will be described below, is performed, a fastening means, such as a bolt, is tightened into each locking part, thus firmly locking the heating device 5 using waste engine heat.

Referring to FIG. 9, the first step 42 is provided on the upper surface of the flange 41 to have a smaller diameter than that of the flange, and extends upwards from the upper surface of the flange to a predetermined length. The first step is opened at one side thereof, while is closed at the other side thereof, thus defining a predetermined space therein. The first step includes a coolant storage part 421 and a water outlet hole 422.

Referring to FIGS. 9 to 11, the coolant storage part 421 is the space for temporarily storing the coolant fed into the flange 41 by the first step 42. According to another embodiment of the invention, a projection 4211 may be additionally provided around the water outlet hole of the coolant storage part 421. That is, a radius from the projection to the center of the coolant storage part is set as R5. The radius of the coolant storage part is gradually increased continuously or discontinuously in a circumferential direction from the projection, so that the radius R7 around the water outlet hole 422 has a maximum radius (i.e., R7>R6>R5). Thereby, when the coolant discharged from the rotor to the lid performs rotary motion by the rotation of the rotor, the moment is increased, so that the hydraulic energy of the coolant discharged to the water outlet part can be increased.

The water outlet hole 422 is the through hole which is formed at a predetermined position in the inner circumference of the coolant storage part 421 to discharge the coolant, and communicates with the water outlet part 45 of the lid 4, which will be described below, thus discharging the coolant to the outside.

Referring to FIG. 9, the second step 43 is the shape of a hollow ring which is provided on the upper surface of the first step 42 to have a smaller diameter than that of the first step and extend upwards from the first step to a predetermined length. The second step includes a guide protrusion 431, a coupling protrusion 432, and a coupling hole 433.

As shown in FIG. 10, the guide protrusion 431 extends upwards from the upper surface of the second step 43 to a predetermined length, with a plurality of through holes formed in the sidewall of the guide protrusion to be spaced apart from each other by a predetermined interval. When the assembly of the heating device 5 using waste engine heat, which will be described below, is performed, the guide protrusion is the path which is inserted into the water inlet passage 33 of the rotor 3 and guides the coolant into the water inlet passage 33.

The coupling protrusion 432 is the shape of a cylinder which extends upwards from the upper surface of the guide protrusion 431 to a predetermined length. The coupling protrusion is formed to close an end of the guide protrusion 431.

The coupling hole 433 is the hole which is formed in the coupling protrusion 432 to have a smaller diameter than that of the coupling protrusion and to have a predetermined length. When the assembly of the heating device 5 using waste engine heat, which will be described below, is performed, the support shaft 213 of the rotor body 21 is coupled to the coupling hole.

Referring to FIG. 9, the water inlet part 44 has the shape of a hollow cylinder which extends upwards from the upper surface of the second step 43 to a predetermined length and has a smaller diameter than that of the second step. The water inlet part includes a water inlet hole 441. Further, the water inlet part 44 may be bent laterally from an upper end thereof at a predetermined curvature in such a way as to be parallel to the flange 41. Preferably, the water inlet part extends in a direction opposite to that of the water outlet part 45, which will be described below in detail. Thus, when the heating device 5 using waste engine heat is installed in the vehicle, a coolant line which is cut at a predetermined position and is connected to the heating device has a horizontal state, so that the heating device 5 can be easily installed in the vehicle.

The water inlet hole 441 is the through hole which is formed in the water inlet part 44, and is the path for feeding the coolant to the heating device 5 using waste engine heat.

The water outlet part 45 has the shape of a hollow cylinder which extends laterally from the flange 41 to a predetermined length, and is the path which is connected to the water outlet hole 422 formed in the first step 42 so as to discharge the coolant.

According to another embodiment of this invention which is not shown in the drawings, the lid 4 may not have the first step 42 and the second step 43, but the flange 41 may be formed to have the construction of the first step 42 and the second step 43 therein. In this case, no step is provided on the outer portion of the flange 41.

Hereinafter, the assembly of the heating device 5 using waste engine heat will be described in detail with reference to FIG. 3.

The body 21 of the receiving part 2 is inserted into the receiving part insert cavity 12 of the main body 1. In this case, the first coupling surface 222 (see, FIG. 7) provided on the flange 22 of the receiving part 2 is supported by the upper surface of the main body 1. The protruding surface 221 (see, FIG. 7) of the flange 22, having a radius which is equal to the radius R1 of the main body 1, is inserted into the main body 1 to be secured thereto.

The rotor body 31 of the rotor 3 is inserted into the rotor insert cavity 211 which is formed in the body 21 of the receiving part 2. In this case, the support shaft protrusion 212 (see, FIG. 6) of the body 21 is inserted into the first insert hole 311 (see, FIG. 8) of the rotor body 31, and the support shaft 213 (see, FIG. 6) of the body 21 is inserted into the second insert hole 312 (see, FIG. 8) of the rotor body 31.

The third coupling surface 224, provided on the flange 22 of the receiving part 2, is inserted into the sealing groove 413 (see, FIG. 10) of the lid 4. In this case, the guide protrusion 431 (see, FIG. 10) provided on the second step 43 of the lid 4 is inserted into the water inlet passage 33 of the rotor 3, so that the support shaft 212 provided in the body 21 of the receiving part 2 is coupled to the coupling hole 433 (see, FIG. 10) of the second step 43.

In this way, the heating device 5 using waste engine heat is loosely assembled.

By tightening fastening means, such as bolts, into the holes formed in the first locking parts 15 of the main body 1, the second locking parts 226 of the receiving part 2, and the third locking parts 415 of the lid 4, the heating device 5 using waste engine heat is firmly assembled.

The operation of the heating device 5 using waste engine heat will be described below in detail with reference to the accompanying drawings.

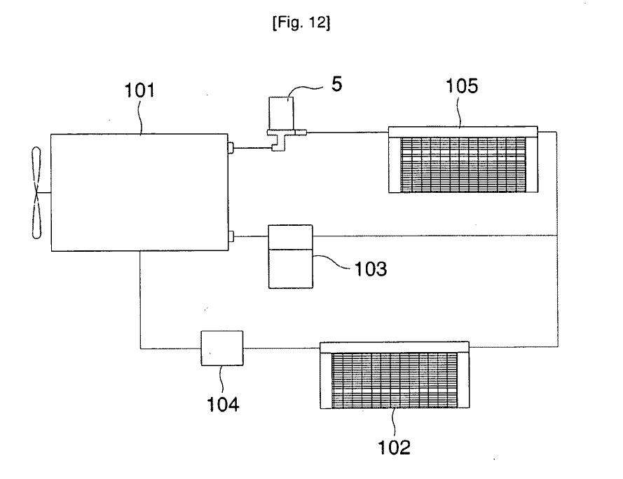

FIG. 12 is a schematic view showing the use of the heating device using waste engine heat, according to the present invention.

Referring to FIG. 12, when the engine 101 is being operated, the heating device 5 using waste engine heat is not operated, but simply serves as a coolant flow path, as a water pump 103 operates.

When the engine 101 is stopped, the operation of the heating device will be described with reference to FIGS. 3, 4, and 12.

That is, the heating device is controlled by the control unit 13 of the main body 1 so that an electric current is supplied from the battery of the vehicle to the coils 121 which are provided in the driving part 11 of the main body 1. Thereby, the driving part 11 is magnetized, so that the rotor body 31 having the polarity opposite that of the driving part reacts to the magnetism of the driving part 11. At this time, depending on a varying polarity, the rotor 3 is rotated.

As the rotor 3 rotates, the coolant is fed from the engine 101 through the water inlet part 44 of the lid 4 to the heating device. The coolant is supplied through the guide protrusion 431 provided on the second step 43 of the lid 4 into the water inlet passage 33 of the rotor 3.

The coolant, which is fed into the water inlet passage 33 of the rotor 3, is discharged through the discharge holes 332. Subsequently, the coolant passes through the water outlet part 32, and then is supplied to the coolant storage part 421 provided on the first step 42 of the lid 4.

The coolant, which is supplied to the coolant storage part 421, is fed into the rotor while having rotating force transmitted by the rotor 3. The continuous rotation of the rotor 3 and the projection 4211 of the coolant storage part 421 provide increased hydraulic energy and high hydraulic pressure to the coolant. By the increased hydraulic energy and high hydraulic pressure, the coolant is discharged through the water outlet part 45 of the lid 4, and then is supplied to a heater 105.

The heating device 5 using waste engine heat is controlled by the control unit 13 to be driven for a predetermined period.

When the heating device 5 using waste engine heat is installed in the vehicle, the position of the heating device in the vehicle will be described below.

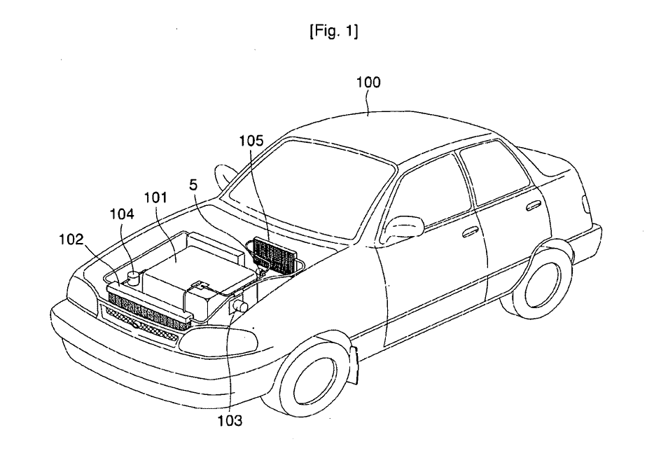

Referring to FIGS. 1 and 12, the vehicle 100 includes a heating system having the engine 101, the water pump 103, a radiator 102, a thermostat 104, and the heater 105. In order to install the heating device 5 in the vehicle, the coolant line coupling the engine 101 with the heater 105 is cut, and then the heating device 5 using waste engine heat according to the present invention is installed at the cut portion. In this way, the heating device of this invention can be simply installed in the vehicle.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A heating device using waste engine heat, comprising:
a main body generating rotating force by an electric current which is supplied from a battery of a vehicle to the main body for a predetermined period, when an engine is stopped;
a receiving part received in the main body, and preventing coolant from flowing into the main body;
a rotor inserted into the receiving part, and receiving the coolant, and rotated depending on a varying polarity, thus discharging the coolant from the rotor; and
a lid introducing the coolant from the engine through a first side of the lid, supplying the coolant to the rotor, and discharging the coolant, which has swirling force while passing through the rotor, to a heater coupled to a second side of the lid.

2. The heating device according to claim 1, wherein
the main body comprises a driving part for driving the rotor, and a control unit for controlling the driving part;
the receiving part comprises a body which is coupled to the main body and receives the rotor therein;
the rotor comprises a rotor body which is operated in conjunction with the driving part to be rotated, and a water outlet part for discharging the coolant from the rotor; and
the lid comprises a water inlet part for introducing the coolant from the engine, a coolant storage part for temporarily storing the coolant fed through the water inlet part, and a water outlet part for discharging the coolant from the coolant storage part to the heater.

3. The heating device according to claim 2, wherein the control unit comprises:
a voltage check part for periodically checking an operating voltage of the vehicle battery;
an operation time check part for checking an operation time of the heating device;
a temperature check part for checking a temperature of the coolant; and
a control part for wholly controlling the heating device, based on data transmitted from the voltage check part, the operation time check part, and the temperature check part.

4. The heating device according to claim 3, wherein the body of the receiving part comprises a support shaft that allows the rotor body to be rotated without deviating from a center, and the rotor comprises a second insert hole that is fitted over the support shaft.

5. The heating device according to claim 2, wherein the coolant storage part further comprises at a predetermined position therein a projection, and a radius of the coolant storage part is increased in a circumferential direction from the projection, so that moment is increased when the coolant rotates by rotation of the rotor, and thereby the coolant is discharged from the coolant storage part while having increased hydraulic energy.

6. The heating device according to claim 2, wherein the lid comprises a guide protrusion for easily supplying the coolant to the rotor, and the rotor further comprises a water inlet passage having a water inlet protrusion which corresponds to the guide protrusion so as to easily introduce the coolant into the rotor.

7. The heating device according to claim 4, wherein the lid further comprises a coupling protrusion having a coupling hole which is coupled to the support shaft protruding from the second insert hole.

8. The heating device according to claim 2, wherein the water inlet part extends upwards from the lid, and then is bent at a predetermined curvature in a direction opposite that of the water outlet part in such a way as to extend laterally.

9. The heating device according to claim 2, wherein the receiving part further comprises a flange, comprising:
a protruding surface inserted into the main body;
a first coupling surface supported on an upper surface of the main body;
a second coupling surface supporting the lid;
a third coupling surface coupled to the lid, and primarily sealing a gap between the receiving part and the lid so as to prevent the coolant from leaking out; and
a packing groove into which a packing member is inserted, thus secondarily sealing the gap between the receiving part and the lid.

10. The heating device according to claim 9, wherein the lid further comprises a lid flange, comprising:
a coupling surface coupled to the second coupling surface;
a sealing groove into which the third coupling surface is inserted;
a sealing surface sealing the packing groove; and
a temporary storage groove for temporarily storing the coolant which leaks through the sealing surface.

11. The heating device according to claim 10, wherein the lid flange comprises on an outer circumference thereof a plurality of third locking parts each having a through hole, the flange of the receiving part comprises on an outer circumference thereof a plurality of second locking parts each having a through hole, and the main body comprises on an outer circumference thereof a plurality of first locking parts each having an internal threaded through hole, the locking parts being integrally coupled to each other using fastening means.
